(19) United States
(12) Patent Application Publication
(10) Pub. No.: US 2007/0150473 A1
(43) Pub. Date: Jun. 28, 2007

(54) Search By Document Type And Relevance

(75) Inventors: Hang Li, Beijing (CN); Yunbo Cao, Beijing (CN); Jun Xu, Tianjin (CN)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/383,638

(22) Filed: May 16, 2006

Related U.S. Application Data
(63) Continuation-in-part of application No. 11/275,326, filed on Dec. 22, 2005.
(60) Provisional application No. 60/793,135, filed on Apr. 18, 2006.

(51) Int. Cl. G06F 7/00

(52) U.S. Cl. 707/7

(57) ABSTRACT

A method of finding documents. A method of finding documents comprising, ranking documents according to relevance to form a ranked relevance list, ranking documents according to type to form a ranked type list, and combining the ranked relevance list and the ranked type list to form a list of documents ranked by relevance and type.

### CROSS-REFERENCE TO RELATED APPLICATION

This application is a continuation-in-part of application Ser. No. 11/275326, filed Dec. 22, 2005, and also claims priority to provisional patent application Ser. No. 60/793,135 filed Apr. 18, 2006 the disclosure of which is incorporated herein by reference.

### BACKGROUND

This description relates generally to computer aided searching and more specifically to searching for genres of documents.

People often search for documents on the web. Much effort has been made to cope with finding the desired document from the multitude of information available on the web. Often users submit queries to the search system and the search system returns relevant documents with respect to the queries.

In many cases, when users conduct search, they not only know what kind of ‘document contents’ which they look for, but also know what kind of ‘types’ the documents belong to. For example, sometimes users know that they should search for information from technical papers, homepages, shopping sites, or instruction documents.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a way to search for documents by combining a relevance model and a type model. Training data is provided to each model and the model is then applied to a first plurality of documents. Two collections of documents result. A first collection ranked by type, and a second collection ranked by relevance. Through a linear combination, or alternatively by thresholding, the documents are combined to produce a second plurality of documents ranked by relevance and type. Illustrative examples are provided showing how to use the examples provided to implement searches for instruction documents and course web pages of colleges.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows two examples of web documents that may be found in a search.

FIG. 2 is a diagram showing examples of various document types can be considered in a typed search.

FIG. 3 is a flow diagram showing manuals search by using a relevance model and a type model.

FIG. 4 illustrates an exemplary computing environment 500 in which the manuals search by using a relevance model and a type model described in this application, may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a searching by using a relevance model and a type model. Although the present examples are described and illustrated herein as being implemented in an instruction manual search system and a college web page search system, the system described is provided as an example and not a limitation. As those skilled in the art will appreciate, the present examples are suitable for application in a variety of different types of search systems.

Traditional information retrieval typically aims at finding relevant documents. However, relevant documents found in this manner are not necessarily the desired documents. Thus, a naive application of the traditional information retrieval may not produce the desired instructions.

The examples below address what is called ‘typed search’. Specifically, given a query and a designated document type (e.g., instruction document or homepage), the search system retrieves and ranks documents not only based on the relevance to the query, but also based on the likelihood of being in the designated document type. Traditional document retrieval is typically designed for searching for relevant documents and thus typically not suitable to the task. The examples below include a framework consisting of ‘relevance model’ and ‘type model. The relevance model determines whether or not a document is relevant to a query. The type model determines whether or not a document belongs to the designated document type. BM25 and Logistic Regression can be employed as the relevance model and the type model, respectively. Two possible ways of combing the models can be considered. One is based on linear combination, and the other based on thresholding.

In typed search, users typically type queries as usual and at the same time are asked to designate the document types which they want (if it is possible), and the system returns not only documents relevant to the queries, but also those likely to be the designated type. Several ways for users to designate document types can be considered, for example, offering an advanced search menu or preparing a special search operator (e.g., “doctype: paper”). In this way, the numbers of documents in search results which the users need to examine may be drastically reduced. It may be possible to help users to quickly find information.

In typed search users search for documents in designated ‘document types’. Here, document type may mean genre of document (e.g., technical paper) or functional category of web page (homepage). Obviously, file types are easy to identify, while document types may not.

Two probabilistic models may be used for typed search: relevance model and type model. The former represents the relevance of documents to queries, and the latter represents the likelihood of documents being in the designated type. Okapi and Logistic Regression can be examples of the two models, respectively. Given a query and a document type, relevant documents in the designated types are often ranked higher using the exemplary approach than the baseline methods of solely using Okapi, solely using Logistic Regression, using Okapi and heuristic rules, and using query expansion plus Okapi.

In the examples provided two possible ways of combing the relevance and type models may be used: linear combination and thresholding. It is typically better to take the linear combination strategy when the type is hard to determine and it may be better to take the thresholding strategy when the type is easy to detect.

In the examples provided typed search tends to perform well on instruction document search and course page search. It is also possible to conduct domain adaptation of type model. Therefore, it seems to be feasible to create generic typed search systems. A homepage search can be regarded as a specific ‘typed search’. In homepage search, both relevance information and type information may be needed in web pages ranking.

Okapi and Logistic Regression

Okapi is a system for document retrieval based on a probabilistic model. It retrieves and ranks documents according to the relevance of documents to queries. Okapi or its equivalent may be employed in the example provided. Okapi is described more fully by S. E. Robertson, S. Walker, M. M. Beaulieu, M. Gatford, and A. Payne. Okapi at TREC-4. In D. K. Harman, editor, The Fourth Text Retrieval Conference (TREC-4), pages 73-96, Gaithersburg, Md., 1996. National Institute of Standards and Technology, Special Publication 500-236.

Logistic Regression (LR) is one model for classification, among other models such as Support Vector Machine (SVM). In contrast to SVM, LR outputs probability values rather than confidence scores in classification. Logistic Regression is a probabilistic classification model more fully described in T. Hastie, R. Tibshirani, and J. Friedman. The Elements of Statistical Learning. Springer, New York, 2001. In contrast to other classification models such as Support Vector Machine (SVM), Logistic Regression typically outputs probability values rather than scores in classification.

Typed Search

The search system may have a mechanism allowing users to designate the types of documents which users can search for. The type of a document (or web page) represents the genre of the document (or the functional category of the webpage). Users can use a menu or a special search operator to designate document types.

When users know what type of documents which they search for, they can check the type. They can then type a search query as usual. The search system receives the query and the document type. It typically automatically retrieves and ranks documents on the basis of not only relevance of documents to the query but also likelihood of the documents in the same type.

Typed search is useful for helping users to find information. Traditional information retrieval typically conducts searches on the basis of relevance of documents to the query. Similarly, typed search may need to assure that the retrieved documents are relevant to the query as well. However, typed search also typically needs to assure that the retrieved documents belong to the designated type. Table 1 shows two views of documents:

TABLE 1
Two views of documents

| | Relevant | Irrelevant |
|---|---|---|
| Designated | A | B |
| Non-Designated Type | C | D |

From Table 1, we see that A is the set of documents that we want to collect in typed search. C is the set that is relevant but not the designated type and thus should be filtered out. By introducing types into search, one can drastically reduce the numbers of documents returned to users to check.

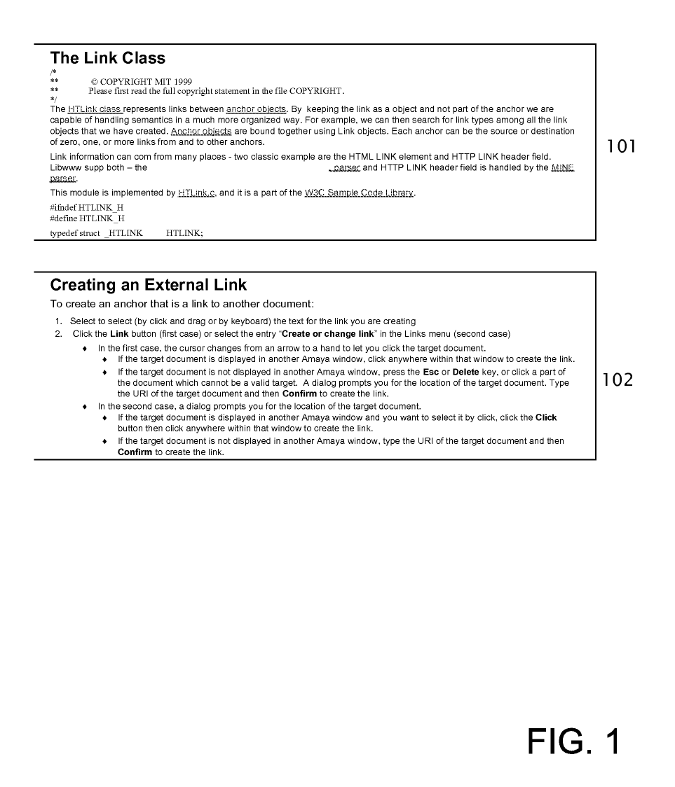

FIG. 1 shows two examples of web documents that may be found in an instruction document, or manuals search. The first document 101 is not an instruction document and the second document 102 is an instruction document. Let us use instruction document (manuals) search as example. Thus, if the query is ‘how to create a link’, then the second document 102 would be preferred by users. However, if only relevance is considered, then the first document 101 will likely be ranked higher, because it would typically appear to be more relevant to the query.

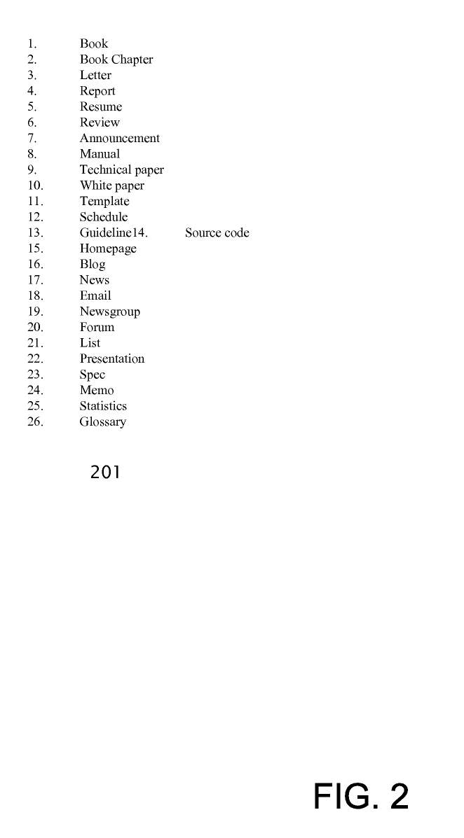

FIG. 2 is a diagram showing examples of various document types can be considered in a typed search. As seen above judging whether a document is a relevant instruction document and of a given type can be used as an answer to a how-to query in an objective way may be hard. However, we can still provide relatively objective guidelines for the judgment. The specification may be used extensively for development and evaluation of the manuals search process. As previously shown in Table 1, the specification can be designed from two view points. For the notion of relevance, specification may be defined in a similar fashion as that in traditional information retrieval

General Framework

A general framework for typed search, specifically a general mechanism for ranking in typed search is provided.

Given a query q and a document d, the documents are ranked with the conditional probability of r and t:
Pr(r,t|q,d) (1)
where random variables r and t take 1 or 0 as values and they respectively denote ‘relevant or not’ and ‘in the same type or not’. In instruction document search, for example, t=1 means that a document is an instruction document. In typed search, documents using the probability scores of documents calculated by equation (1) are ranked.

Here, assume that r and t are conditionally independent given q and d. Further assume that t is not dependent on q given d. Hence:
Pr(r,|q,d)≈Pr(r|q,d)Pr(t|q,d)≈Pr(r|q,d)·Pr(t|d) (2)

Equation (2) may be taken as a more general model for typed search. Calling the two sub-models ‘relevance model’and ‘type model’, respectively. The relevance model judges whether or not a document is relevant to the query. The type model judges whether or not a document is in the designated document type.

Kraajj et al. have proposed using Language Model in home/named page finding. Kraajj et al. employs a model as follows, which assigns a score to page d with respect to query q:
Pr(d|q)∝Pr(d)·Pr(q|d) (3)

The first model on the right hand side, referred to by them as ‘prior’, corresponds to the type model in equation (2) and the second model corresponds to the relevance model. The relevance model, type model, and their combinations will be described in more details.

For further information on using a Language Model see W. Kraajj, T. Westerveld and D. Hiemstra. The Importance of Prior Probabilities for Entry Page Search. In Proc. of the 25th annual international ACM SIGIR conference on research and development in information retrieval, 2002. The contents of which are incorporated in this patent application in their entirety

Relevance Model

Given a query and a document, the relevance model outputs a relevance score. In typed search, for a given query, a list of <document, relevance_score> pairs using the relevance model is created. In this example, Okapi's BM25 is employed as the relevance model. For indexing, the title and the body of a document are indexed in separate fields. For each field, the BM25 weighting scheme is used to calculate a score. Next, linearly combine the scores of the title field and the body field, and view the combined score as the relevance_score.

Type Model

Given a document, the type model outputs a type score. In typed search, a list of <document, type_score> pairs using the type model is created. A statistical machine learning approach is taken to construct a type model. More specifically, given a training data set D={xᵢ,yᵢ}ₗⁿ, a model Pr(y|x) is constructed that can minimize the number of errors when predicting y given x (generalization error). Here xᵢ∈X and yᵢ∈{1,−1}·x represents a document and y represents whether or not a document is a document in the designated type. When applied to a new document x, the model predicts the corresponding yand outputs the score of the prediction. In this example, Logistic Regression is adopted as type model. The Logistic Regression model calculates the ‘type probability’ of a document according to the following equation.

$$Pr ( y = 1 \text{\textbar} x ) = \frac{1}{1 + {ⅇ}^{- ( {β}_{0} + β \cdot x )}} \qquad ( 4 )$$

The model satisfies

$$log \frac{Pr ( y = 1 \text{\textbar} x )}{1 - Pr ( y = 1 \text{\textbar} x )} = {β}_{0} + β \cdot x \qquad ( 5 )$$

where β represents the coefficients of a linear combination and β₀ represents the intercept. A Logistic Regression model is usually estimated by using Maximum Likelihood.

In this example the type_score of a document is used:

$$type\_score = log \frac{Pr ( y = 1 \text{\textbar} x )}{1 - Pr ( y = 1 \text{\textbar} x )} \qquad ( 6 )$$

Combining Strategy

Two strategies for combing the scores calculated by the relevance and type models may be used. They are linear combination and thresholding respectively. Documents are ranked using the combined scores in typed search.

In linear combination, ranking_score is calculated by linearly interpolating relevance_score and type_score.
ranking_score=λ·type_score+(1−λ)·relevance_score (7)
where λ∈[0,1] is weight . Experimental results tend to indicate that it may be better to have λ=0.5. That is to say, Equation (2) may be used exactly.

In thresholding, the ranking_score is calculated by descretizing type_score to 1 or 0 based on a predetermined threshold.

$$ranking\_score = \{ \begin{matrix}relevance\_score & if type\_score > θ \\ 0 & otherwise\end{matrix} \qquad ( 8 )$$

where θ>0 is threshold.
System Architecture

A general architecture for typed search systems may be considered. Since in the exemplary approach (2), type model and relevance model can be constructed independently, it is easy to develop a typed search system that support searches on multiple types. Actually, for each type, the type scores of documents using the type model may be calculated and stored in a database table. In search, the relevance scores (BM25) are calculated and combined with type scores (6) using one of the combing strategy in real time.

In the given example, given a query, a document type, and a document collection, the ranking score of each of the documents with respect to the query and the document type may be calculated. In an example, the top 100 documents are collected and ranked by the relevance model (Okapi). Next the type scores only for the top 100 documents are calculated. In this way a typed search may be executed very efficiently.

Instruction Document Search and Course Page Search

In the examples of instruction document searches and Course page searches course page search and instruction document search are taken as case studies.

Course Page Search

In the example of course page search, it is assumed that the type of documents is course page (in universities). In this example, for course page search, the features in the Logistic Regression model as described below are used. Most features are typically created to characterize title, first heading and URL of documents. Title may be the text enclosed by the HTML tag ‘<title>’ and ‘</title>’, or an equivalent structure. Heading may be the text enclosed by the HTML tag ‘<H1 −6>’ and ‘</H1-6>’, or their equivalents. First heading refers to the first non-empty heading of a HTML document. URL information is also used in course page search.

‘Course’

Whether or not the title of a document contains the word of ‘course’ or ‘course’ plus a 3-digital or 4-digital number, e.g., ‘Course156’, may be an important indicator. This may be represented by using a binary feature. Similar features may be provided with regard to the first heading and URL of a document.

‘CS’ or ‘CSE’

Whether or not the title of a document has a substring that consists of “CS”, “CSE”, or ‘CS’, ‘CSE’ plus a 3-digital or 4-digital number, e.g., “CS324”, may be an important indicator, this is represented using a binary feature. Similar features may be provided with regard to the first heading and URL of a document.

‘Season’

Whether or not the title of a document contains word “Spring”, “SP”, “Fall”, “CurrentQtr”, or “CurrentQuarte” may be an important indicator. This may be represented using a binary feature. Similar features with regard to the first heading and URL of a document may be provided.

‘URL’

Whether or not the URL is ended with a ‘/’ is typically an important feature. This binary feature typically applies to URL fields only.

Instruction Document Search

In instruction document search, it may be assumed that the type of documents is instruction document (or manual). What is typically considered in this example is the creation of the type model, specifically, the definition of features contained in the type model (Logistic Regression model). In this example, for instruction document search, binary or real valued features as described below is utilized.

Most features are created to characterize title, first heading and first sentence of documents. Title and first heading are typically the same as described for course page search. In this example the first sentence is the first sentence appearing in the body of a HTML document.

‘How To’

Whether or not the title of a document contains the words of ‘how to’, ‘howto’ or ‘how-to’ is typically an important indicator. This may be represented this using a binary feature. Similar features with regard to the first heading and the first sentence of a document may be provided.

‘Doing Something’

The appearance of the suffix ‘ing’ in the first word of the title is typically another indicator of an instruction document. Sometimes people use the template of ‘doing something’ instead of ‘how to do something’ for the title of an instruction document. The value of the feature is also binary. Similar features have also been defined for the first heading and the first sentence.

Text Length

The following real-valued feature may defined:
log(length(title)+1) (9)
where length(title) denotes the number of words in the title. A document with a short title (e.g. a one-word title) tends to be a non-instruction document. Similar features have also been defined for the first heading and the first sentence.
Identical Expressions

If the texts in any two of the three parts: title, first heading and first sentence are identical, then this feature is 1. Otherwise, it is 0. An instruction document usually repeats its topic in these three places.

Bag of Words

The ‘bag-of-words’ features may be relied upon. High frequency words in the titles of the documents in training data are collected and a bag of the keywords is created. Some keywords play positive roles (e.g., ‘troubleshoot’, ‘wizards’) and some play negative roles (e.g., ‘contact’). Each keyword corresponds to a binary feature. If the title of a document contains a keyword, then the corresponding binary feature will be 1, otherwise 0. The number of the features of this kind is the number of the keywords. Similar features have been defined for the first heading and the first sentence.

In the examples provided, a ‘typed search’ is addressed where search documents not only based on the relevance, but also based on the likelihood of being in the designated document type. There may be many document types e.g., course page, instruction document, homepage etc. A ‘typed search’ may be constructed by combining two probability models: a relevance model and a type model. Okapi and Logistic Regression may be used as the relevance model and the type model, respectively. Two approaches are proposed to obtain the final ranking scores. One is based on the linear combination and another is based on thresholding. Both of the two combination methods perform well in real-world. Since the relevance model and type model are independent and the type scores can be calculated offline, a system which conducts typed search with multiple document types efficiently may be implemented.

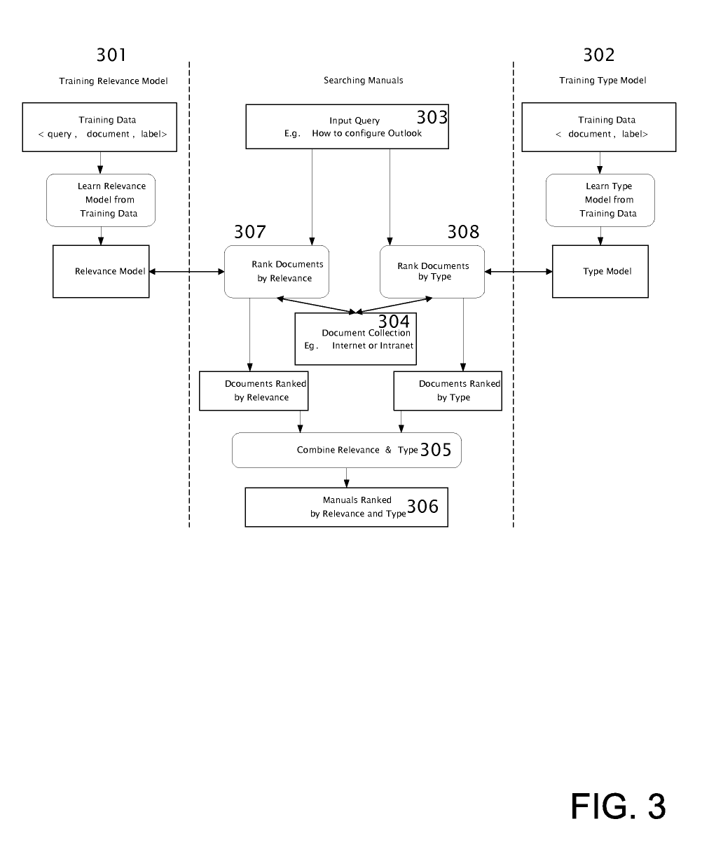

FIG. 3 is a flow diagram showing a search by using a relevance model 301 and a type model 302. In the example provided of manuals search by using a relevance model and a type model the input may be a query 303 and a collection of documents 304. The documents may have resulted from a conventional search, or may simply be a collection of documents to be examined. The exemplary approach to manuals search includes two steps. First, a representation to relevance to a query and a likelihood of being an instruction document is formed with two sub-models, which we call a ‘relevance model’ 301 and a ‘type model’ 302, respectively. In the relevance model, it is judged whether or not a document in the input is relevant to the query 307. In the type model, it is judged whether or not a document in the input is an instruction document 308. Next, a combining strategy may be used to combine the scores output from the two sub-models 305. Combining Strategies may include linear combination, or thresholding. The documents are then ranked in descending order of their combined scores 306.

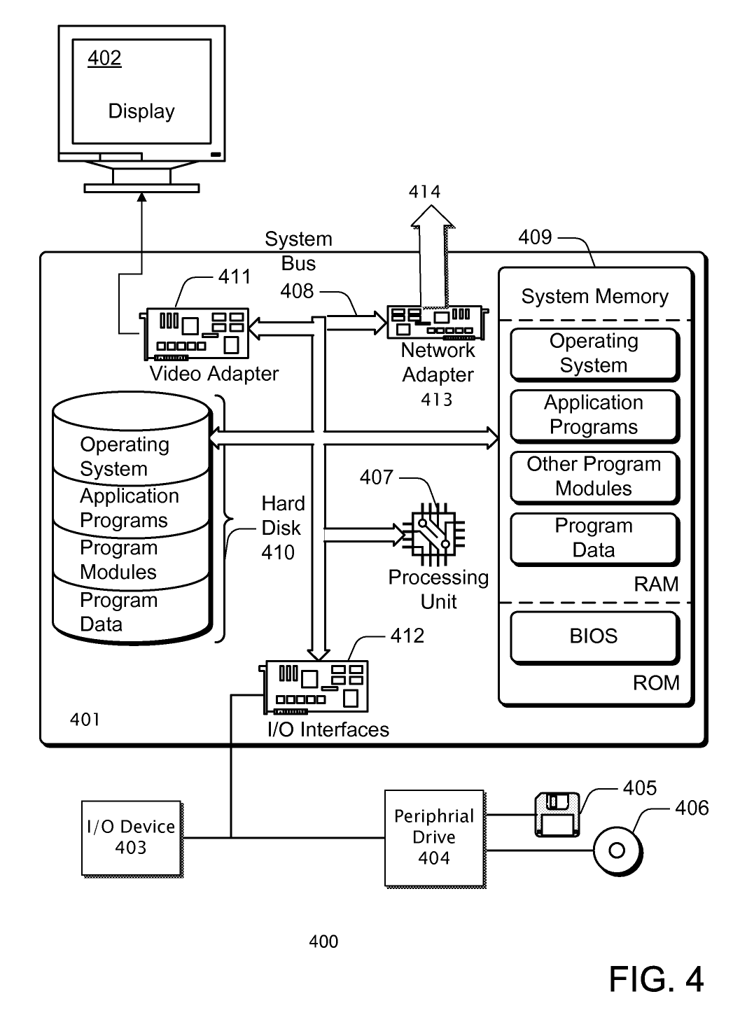

FIG. 4 illustrates an exemplary computing environment 400 in which the manuals search by using a relevance model and a type model described in this application, may be implemented. Exemplary computing environment 400 is only one example of a computing system and is not intended to limit the examples described in this application to this particular computing environment.

For example the computing environment 400 can be implemented with numerous other general purpose or special purpose computing system configurations. Examples of well known computing systems, may include, but are not limited to, personal computers, hand-held or laptop devices, microprocessor-based systems, multiprocessor systems, set top boxes, gaming consoles, consumer electronics, cellular telephones, PDAs, and the like.

The computer 400 includes a general-purpose computing system in the form of a computing device 401. The components of computing device 401 can include one or more processors (including CPUs, GPUs, microprocessors and the like) 407, a system memory 409, and a system bus 408 that couples the various system components. Processor 407 processes various computer executable instructions, including those to ** to control the operation of computing device 401 and to communicate with other electronic and computing devices (not shown). The system bus 408 represents any number of several types of bus structures, including a memory bus or memory controller, a peripheral bus, an accelerated graphics port, and a processor or local bus using any of a variety of bus architectures.

The system memory 409 includes computer-readable media in the form of volatile memory, such as random access memory (RAM), and/or non-volatile memory, such as read only memory (ROM). A basic input/output system (BIOS) is stored in ROM. RAM typically contains data and/or program modules that are immediately accessible to and/or presently operated on by one or more of the processors 407.

Mass storage devices 404 may be coupled to the computing device 401 or incorporated into the computing device by coupling to the buss. Such mass storage devices 404 may include a magnetic disk drive which reads from and writes to a removable, non volatile magnetic disk (e.g., a “floppy disk”) 405, or an optical disk drive that reads from and/or writes to a removable, non-volatile optical disk such as a CD ROM or the like 406. Computer readable media 405, 406 typically embody computer readable instructions, data structures, program modules and the like supplied on floppy disks, CDs, portable memory sticks and the like.

Any number of program modules can be stored on the hard disk 410, Mass storage device 404, ROM and/or RAM 409, including by way of example, an operating system, one or more application programs, other program modules, and program data. Each of such operating system, application programs, other program modules and program data (or some combination thereof) may include an embodiment of the systems and methods described herein.

A display device 402 can be connected to the system bus 408 via an interface, such as a video adapter 411. A user can interface with computing device 702 via any number of different input devices 403 such as a keyboard, pointing device, joystick, game pad, serial port, and/or the like. These and other input devices are connected to the processors 407 via input/output interfaces 412 that are coupled to the system bus 408, but may be connected by other interface and bus structures, such as a parallel port, game port, and/or a universal serial bus (USB).

Computing device 400 can operate in a networked environment using connections to one or more remote computers through one or more local area networks (LANs), wide area networks (WANs) and the like. The computing device 401 is connected to a network 414 via a network adapter 413 or alternatively by a modem, DSL, ISDN interface or the like.

Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A method of searching by document type comprising:
ranking documents according to relevance to form a ranked relevance list:
ranking documents according to type to form a ranked type list; and
combining the ranked relevance list and the ranked type list to form a list of documents ranked by relevance and type.

2. The method of searching by document type of claim 1 further comprising learning a relevance model from a set of relevance model training data.

3. The method of searching by document type of claim 2 in which the relevance model set of training data includes a query, a document, and a label.

4. The method of searching by document type of claim 1 further comprising learning a type model from a set of type training data.

5. The method of searching by document type of claim 4 in which the type model set of training data includes a document and a label.

6. The method of searching by document type of claim 1 in which interpolation is performed by linear combination.

7. The method of searching by document type of claim 1 in which interpolation is performed by thresholding.

8. The method of searching by document type of claim 1 in which ranking documents according to relevance to form a ranked relevance list is performed by a document relevance search.

9. The method of searching by document type of claim 8 in which the document relevance search is Okapi.

10. The method searching by document type of claim 1 in which ranking documents according to type to form a ranked type list is performed by a classifier.

11. The method searching by document type of claim 10 in which the classifier is logistic regression.

12. A computer readable media encoded to perform a typed search comprising:
performing a typed search to produce a first result and a second result; and
combining the first result and the second result.

13. The computer readable media encoded to perform a typed search of claim 12 in which combining is performed by linear combination.

14. The computer readable media encoded to perform a typed search of claim 12 in which combining is performed by thresholding.

15. The computer readable media encoded to perform a typed search of claim 12 in which the typed search includes utilizing a type model.

16. The computer readable media encoded to perform a typed search of claim 12 in which the typed search includes utilizing a relevance model.

17. A system for searching by document type comprising:
a means for determining a relevance model producing a first result;
a means for determining a type model for producing a second result; and
a means for combining the first result and the second result.

18. The system for searching by document type of claim 17 in which the means for combining includes a means for linearly combining the first result and the second result.

19. The system for searching by document type of claim 17 in which the means for combining includes a means for thresholding the first result and the second result.

20. The system for searching by document type of claim 17 in which an instruction document is found.
